(19) United States
(12) Patent Application Publication
(10) Pub. No.: US 2013/0307838 A1
(43) Pub. Date: Nov. 21, 2013

(54) SOURCE DRIVER AND A METHOD OF OPERATING THE SAME

(71) Applicant: SAMSUNG ELECTRONICS CO., LTD., Suwon-si (KR)

(72) Inventors: Seung-hyun KIM, Hwaseong-si (KR); Jae-Youn Lee, Yongin-si (KR); Sang-hoon Lim, Seongnam-si (KR)

(73) Assignee: SAMSUNG ELECTRONICS CO., LTD., Suwon-si (KR)

(21) Appl. No.: 13/895,475

(22) Filed: May 16, 2013

(30) Foreign Application Priority Data
May 18, 2012 (KR) 10-2012-0053154

(51) Int. Cl. G09G 5/00

(52) U.S. Cl. CPC G09G 5/001
USPC 345/212

(57) ABSTRACT

A source driver including a first source driving unit including a first source amplifier controlling a first slew rate in response to a first bias control signal and generating a first driving voltage of first display data; a second source driving unit including a second source amplifier controlling a second slew rate in response to a second bias control signal and generating a second driving voltage of second display data; and a bias control signal generating unit sequentially generating the first and second bias control signals, and applying the first and second bias control signals respectively to the first and second source driving units, wherein the first bias control signal is based on a difference between the first display data sequentially applied to the first source amplifier and the second bias control signal is based on a difference between the second display data applied to the second source amplifier.

### CROSS-REFERENCE TO RELATED APPLICATION

This application claims priority under 35 U.S.C. §119 to Korean Patent Application. No. 10-2012-0053154, filed on May 18, 2012, in the Korean Intellectual Property Office, the disclosure of which is incorporated by reference herein in its entirety.

### BACKGROUND

1. Technical Field

The inventive concept relates to a source driver and a method of operating the same, and more particularly, to a source driver which may adjust a slew rate, a display device including the source driver, and a method of operating the source driver.

2. Discussion of the Related Art

As resolution and size of a display panel increase, a source driver with a high slew rate and low power operation may be used to display a high-quality image.

### SUMMARY

An exemplary embodiment of the inventive concept provides a source driver which minimizes power consumption by adaptively adjusting a slew rate of a source amplifier, a display device including the source driver, and a method of operating the source driver.

According to an exemplary embodiment of the inventive concept, there is provided a source driver for a display device, the source driver including: a first source driving unit including a first source amplifier that controls a first slew rate in response to a first bias control signal and generates a first source driving voltage corresponding to first display data; a second source driving unit including a second source amplifier that controls a second slew rate in response to a second bias control signal and generates a second source driving voltage corresponding to second display data; and a bias control signal generating unit that sequentially generates the first and second bias control signals, and applies the first and second bias control signals respectively to the first and second source driving units, wherein the first bias control signal is based on a difference between the first display data sequentially applied to the first source amplifier and the second bias control signal is based on a difference between the second display data applied to the second source amplifier.

The first source amplifier may adjust the first slew rate by controlling an amount of a bias current in response to the first bias control signal. The bias control signal generating unit may generate the first bias control signal to increase a bias current of the first source amplifier as the difference between the first display data increases.

The source driver may further include a bias voltage generating unit that applies a bias voltage to the first source amplifier, wherein a bias current of the first source amplifier is generated in response to the bias voltage, and an amount of the bias current is controlled in response to the first bias control signal.

The first display data may include current display data and previous display data that is applied to the first source amplifier prior to the current display data, wherein the bias control signal generating unit includes: a line buffer that buffers at least part of the previous display data and outputs the at least part as previous data; and a comparison unit that generates the first bias control signal based on a difference between the previous data and current data corresponding to at least part of the current display data.

The first source driving unit may include: a data latch that receives and stores the first bias control signal and the first display data; a digital-analog conversion unit that selects and outputs a gray-scale voltage corresponding to the first display data from among a plurality of gray-scale voltages; and the first source amplifier that controls the first slew rate to be adjusted in response to the first bias control signal, and outputs the selected gray-scale voltage as the first source driving voltage.

The first source driving unit may sequentially drive a plurality of source lines of a display panel in a time-division manner. The first display data may include previous display data and current display data that are sequentially applied to the first source driving unit and each of the previous and current display data include first data, second data, and third data sequentially applied to the first source amplifier, and the bias control signal generating unit includes: a line buffer that buffers the third data of the previous display data and outputs the third data as previous data; a first comparator that generates a first sub-bias control signal based on a difference between the previous data and the first data of the current display data; a second comparator that generates a second sub-bias control signal based on a difference between the first data and the second data of the current display data; and a third comparator that generates a third sub-bias control signal based on a difference between the second data and the third data of the current display data.

The bias control signal generating unit may generate the first, second, and third sub-bias control signals, and output the first, second, and third sub-bias control signals as the first bias control signal to the first source driving unit.

The first source driving unit may include: a data latch that receives and stores the first, second, and third sub-bias control signals and the current first, second, and third data; a multiplexer that sequentially selects and outputs the first, second, and third sub-bias control signals in response to a channel selection signal, and sequentially selects and outputs the current first, second, and third data; a digital-analog conversion unit that selects a gray-scale voltage corresponding to the selected data from among a plurality of gray-scale voltages; the first source amplifier that controls the first slew rate to be adjusted in response to the selected sub-bias control signal, and outputs the selected gray-scale voltage as the source driving voltage; and a channel selection unit that sequentially outputs the source driving voltage through a first channel, a second channel, and a third channel in response to the channel selection signal

According to an exemplary embodiment of the inventive concept, there is provided a method of operating a source driver including a plurality of source amplifiers, the method including: generating a plurality of bias control signals based on a difference between display data sequentially applied to the plurality of the source amplifiers; respectively controlling slew rates of the plurality of source amplifiers based on the plurality of bias control signals; and generating source driving voltages using the plurality of source amplifiers.

The plurality of bias control signals may be sequentially generated in a bias control signal generating unit, and each of the plurality of bias control signals is applied to a corresponding one of the plurality of source amplifiers.

Generating the plurality of bias control signals may include: generating a first bias control signal of the plurality of bias control signals based on a difference between previous display data output from a line buffer and current display data; and storing the current display data in the line buffer.

The display data may include first data, second data and third data, and each of the plurality of bias control signals include first, second and third sub-bias control signals, and wherein generating a first bias control signal of the plurality of bias control signals includes: generating the first sub-bias control signal based on a difference between the third data of previous display data output from a line buffer and the first data of current display data; generating the second sub-bias control signal based on a difference between the first data and the second data of the current display data; generating the third sub-bias control signal based on a difference between the second data and the third data of the current display data; and storing the third data of the current display data in the line buffer.

A first source amplifier of the plurality of source amplifiers may output a source driving voltage corresponding to the first data of the current display data when a slew rate of the first source amplifier is adjusted by the first sub-bias control signal, output a source driving voltage corresponding to the second data of the current display data when the slew rate of the first source amplifier is adjusted by the second sub-bias control signal, and output a source driving voltage corresponding to the third data of the current display data when the slew rate of the first source amplifier is adjusted by the third sub-bias control signal.

According to an exemplary embodiment of the inventive concept, a source driving unit configured to output a source driving voltage in response to a bias control signal; and a bias control signal generating unit configured to generate the bias control signal in response to first display data stored in the bias control signal generating unit and second display data input to the bias control signal generating unit.

A slew rate of the source driving voltage is changed by the bias control signal.

The bias control signal includes first and second sub-bias control signals.

A first bias current corresponding to the first sub-bias control signal is different than a second bias current corresponding to the second sub-bias control signal.

The bias control signal generating unit includes a buffer to store the first display data and a comparator to compare the first display data with the second display data.

### BRIEF DESCRIPTION OF THE DRAWINGS

The above and other features of the inventive concept will become more apparent by describing in detail exemplary embodiments thereof with reference to the accompanying drawings in which:

FIG. 1 is a block diagram illustrating a source driver according to an exemplary embodiment of the inventive concept;

FIG. 2 is a block diagram illustrating a bias control signal generating unit of FIG. 1, according to an exemplary embodiment of the inventive concept;

FIG. 3 is a block diagram illustrating a source driving unit of FIG. 1, according to an exemplary embodiment of the inventive concept;

FIG. 4 is a block diagram illustrating a source amplifier of FIG. 3, according to an exemplary embodiment of the inventive concept;

FIG. 5 is a timing chart illustrating waveforms of signals of the source driver including the bias control signal generating unit of FIG. 2 and the source driving unit of FIG. 3, according to an exemplary embodiment of the inventive concept;

FIG. 6 is a block diagram illustrating a bias control signal generating unit of FIG. 1, according to an exemplary embodiment of the inventive concept;

FIG. 7 is a block diagram illustrating a source driving unit of FIG. 1, according to an exemplary embodiment of the inventive concept;

FIG. 8 is a timing chart illustrating waveforms of signals of the source driver including the bias control signal generating unit of FIG. 6 and the source driving unit of FIG. 7, according to an exemplary embodiment of the inventive concept; and

FIG. 9 is a block diagram illustrating a display device according to an exemplary embodiment of the inventive concept.

### DETAILED DESCRIPTION OF THE EMBODIMENTS

Hereinafter, exemplary embodiments of the inventive concept will be described in detail with reference to the accompanying drawings. The inventive concept may, however, be embodied in many different forms, and should not be construed as being limited to the embodiments set forth herein. Like reference numerals may denote like elements in the specification and drawings.

As used herein, the singular foil is “a,” “an” and “the” are intended to include the plural forms as well, unless the context clearly indicates otherwise.

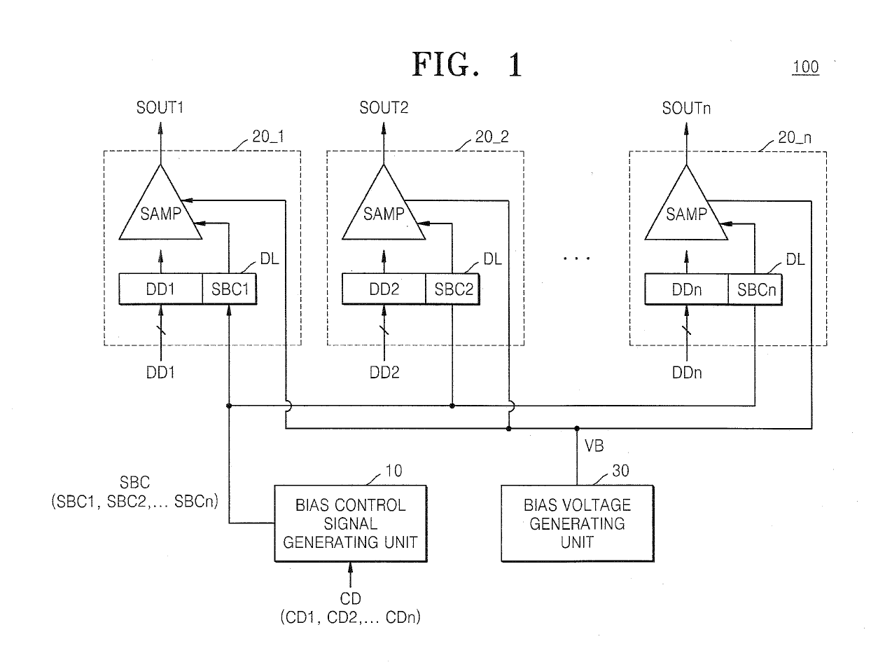

FIG. 1 is a block diagram illustrating a source driver 100 according to an exemplary embodiment of the inventive concept.

Referring to FIG. 1, the source driver 100 may include a bias control signal generating unit 10, a plurality of source driving units 20_1, 20_2, . . . , and 20_n, and a bias voltage generating unit 30.

The plurality of source driving units 20_1, 20_2, . . . , and 20_n respectively receive bias control signals SBC1, SBC2, . . . , and SBCn and display data DD1, DD2, . . . , and DDn, and generate source driving voltages SOUT1, SOUT2, . . . , and SOUTn corresponding to the display data DD1, DD2, . . . , and DDn. Each of the source driving units 20_1, 20_2, . . . , and 20_n may include a data latch DL and a source amplifier SAMP. The data latches DL receive and store the bias control signals SBC1, SBC2, . . . , and SBCn and the display data DD1, DD2, . . . , and DDn. The source amplifiers SAMP allow slew rates to be adjusted in response to the bias control signals SBC1, SBC2, . . . , and SBCn, receive gray-scale voltages corresponding to the display data DD1, DD2, . . . , and DDn output from the data latches DL, and output the source driving voltages SOUT1, SOUT2, . . . , and SOUTn.

The bias control signal generating unit 10 may sequentially generate the plurality of bias control signals SBC1, SBC2, . . . , and SBCn respectively corresponding to the plurality of source driving units 20_1, 20_2, . . . , and 20_n, and may sequentially apply the plurality of bias control signals SBC1, SBC2, . . . , and SBCn to the source driving units 20_1, 20_2, . . . , and 20_n. The bias control signal generating unit 10 may sequentially receive some or all of current data CD1, CD2, . . . , and CDn of the plurality of display data DD1, DD2, . . . , and DDn respectively applied to the plurality of source driving units 20_1, 20_2, . . . , and 20_n, and may sequentially generate the plurality of bias control signals SBC1, SBC2, . . . , and SBCn. For example, after the bias control signal generating unit 10 generates the first bias control signal SBC1 and outputs the first bias control signal SBC1 to the first source driving unit 20_1 corresponding to the first bias control signal SBC1, the bias control signal generating unit 10 may generate the second bias control signal SBC2 and output the second bias control signal SBC2 to the second source driving unit 20_2 corresponding to the second bias control signal SBC2. When the number of source driving units is n, the bias control signal generating unit 10 may respectively apply the bias control signals SBC1, SBC2, . . . , and SBCn to the n source driving units in a time-division manner by repeatedly performing the above process n times.

In this case, the bias control signal generating unit 10 generates and outputs the bias control signals SBC1, SBC2, . . . , and SBCn based on a difference between two pieces of display data sequentially applied to each of the source amplifiers SAMP of the source driving units 20_1, 20_2, . . . , and 20_n. The bias control signals SBC1, SBC2, . . . , and SBCn are signals that control bias currents of the source amplifiers SAMP to adjust slew rates of the source amplifiers SAMP. Two pieces of display data sequentially applied to each of the source amplifiers SAMP respectively correspond to each of the source driving voltages SOUT1, SOUT2, . . . , and SOUTn sequentially output from the source amplifiers SAMP. Accordingly, when a difference between two pieces of display data sequentially applied to the source amplifiers SAMP is high, swing widths of the source driving voltages SOUT1, SOUT2, . . . , and SOUTn are large, and when a difference between two pieces of display data is low, swing widths of the source driving voltages SOUT1, SOUT2, . . . , and SOUTn are small. Accordingly, as a difference between two pieces of display data increases, the bias control signals SBC1, SBC2, . . . , and SBCn are output to increase bias currents of the source amplifiers SAMP.

The bias voltage generating unit 30 generates a bias voltage VB and applies the bias voltage VB to the source amplifiers SAMP of all of the source driving units 20_1, 20_2, . . . , and 20_n.

Since each of the source amplifiers SAMP has to apply a required voltage to a pixel of a display panel within a predetermined time, each of the source amplifiers SAMP has to satisfy a setup time requirement. When a slew rate is high, the source amplifiers SAMP may satisfy the setup time requirements, but power consumption is increased. The source driver 100 according to the present exemplary embodiment allows bias currents required by swing widths of the source driving voltages SOUT, SOUT2, . . . , and SOUTn to adaptively flow through the source amplifiers SAMP of the source driving units 20_1, 20_2, . . . , and 20_n by generating the bias control signals SBC1, SBC2, . . . , and SBCn in consideration of the swing widths, thereby individually controlling slew rates of the source amplifiers SAMP based on the bias control signals SBC1, SBC2, . . . , and SBCn. Accordingly, the source driver 100 prevents excessive bias currents from flowing through the source amplifiers SAMP, thereby reducing power consumption.

In addition, an area of a circuit for generating the bias control signals SBC1, SBC2, . . . , and SBCn may not be significantly increased due to the sequential generation of the plurality of bias control signals SBC1, SBC2, . . . , and SBCn at the bias control signal generating unit 10.

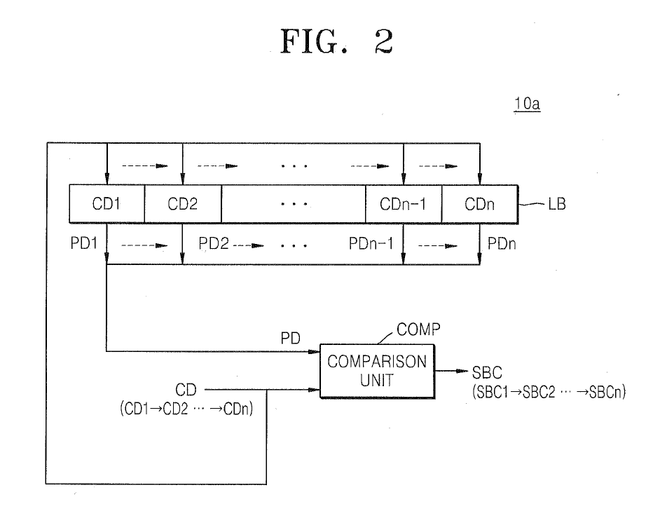

FIG. 2 is a block diagram illustrating a bias control signal generating unit 10a of FIG. 1, according to an exemplary embodiment of the inventive concept.

Referring to FIG. 2, the bias control signal generating unit 10a includes a line buffer LB and a comparison unit COMP, and generates a bias control signal based on current display data applied to each of the plurality of source driving units 20_1 through 20_n (see FIG. 1) and previous display data applied to each of the plurality of source driving units 20_1 through 20_n prior to the current display data. For example, the current display data and the previous display data may correspond to two horizontal lines on a display panel. The previous display data may be data corresponding to a pixel cell of a previous horizontal line already driven on the display panel, and the current display data may data correspond to a pixel cell of a line to be currently driven.

The line buffer LB buffers at least part of the display data, in other words, at least part of the previous display data is delayed a predetermined time and then output as previous data PD. For example, the predetermined time may be the same time as one horizontal line display time of the display panel. The comparison unit COMP generates a bias control signal SBC by comparing current data CD which corresponds to at least part of the current display data with the previous data PD output from the line buffer LB. For example, the current data CD may be high-order 2 bit-data of the current display data, and the previous data PD may be high-order 2-bit data of the previous display data. In this case, the comparison unit COMP may generate the bias control signal SBC by comparing a difference between the previous data PD and the current data CD with a predetermined value. When the previous data PD and the current data CD are high-order 2-bit signals of the previous display data and the current display data, respectively, a relationship between a predetermined value Diff and the bias control signal SBC output from the comparison unit COMP is shown in Table 1.

TABLE 1

| Diff | SBC[1:0] | SBC[3:0] |
|---|---|---|
| 00 | 01 | 0001 |
| 01 | 10 | 0010 |
| 10 | 10 | 0100 |
| 11 | 11 | 1000 |

Table 1 shows results when the bias control signal SBC is a 2-bit signal SBC[1:0] and a 4-bit signal SBC[3:0]. Since the previous data PD and the current data CD are 2-bit data, a data difference may be 4 steps like the predetermined value Diff. For example, when there is no difference between the previous data PD and the current data CD, since the predetermined value Diff is 00, the bias control signal SBC may be 01 or 0001. When a difference between the previous data PD and the current data CD is 2 steps, since the predetermined value Diff is 10, the bias control signal SBC may be 10 or 0100.

Although the predetermined value Diff and the bias control signal SBC may be set by referring to Table 1, it will be understood by one of ordinary skill in the art that the present exemplary embodiment is not limited thereto and various modifications may be made.

Referring back to FIG. 2, after the bias control signal SBC is generated in the comparison unit COMP, the current data CD may be stored in the line buffer LB. The current data CD stored in the line buffer LB may be output as the previous data PD, after a predetermined time passes, for example, in a next horizontal line display time.

The comparison unit COMP sequentially generates the bias control signals SBC1, SBC2, . . . , and SBCn respectively corresponding to the plurality of source driving units 20_1 through 20_n by comparing the current data CD with the previous data PD corresponding to each of the plurality of source driving units 20_1 through 20_n.

TABLE 2

| PD | CD | SBC |
|---|---|---|
| PD1 | CD1 | SBC1 |
| PD2 | CD2 | SBC2 |
| PD3 | CD3 | SBC3 |
| . | . | . |
| . | . | . |
| . | . | . |
| PDn | CDn | SBCn |

Table 2 shows the previous data PD and the current data CD which are applied to the comparison unit COMP and compared with each other and the bias control signal SBC which is output. Referring to Table 2, the comparison unit COMP generates the first bias control signal SBC1 and outputs the first bias control signal SBC1 to the first source driving unit 20_1 by comparing current data CD1 with previous data PD1 of the first display data DD1 (see FIG. 1) applied to the first source driving unit 20_1 (see FIG. 1), and then generates the second bias control signal SBC2 and outputs the second bias control signal SBC2 to the second source driving unit 20_2 by comparing current data CD2 with previous data PD2 of the second display data DD2 (see FIG. 1) applied to the second source driving unit 20_2 (see FIG. 1). The plurality of bias control signals SBC1 through SBCn respectively corresponding to the plurality of source driving units 20_1 through 20_n (see FIG. 1) may be sequentially generated and output to the corresponding source driving units 20_1 through 20_n through the above process.

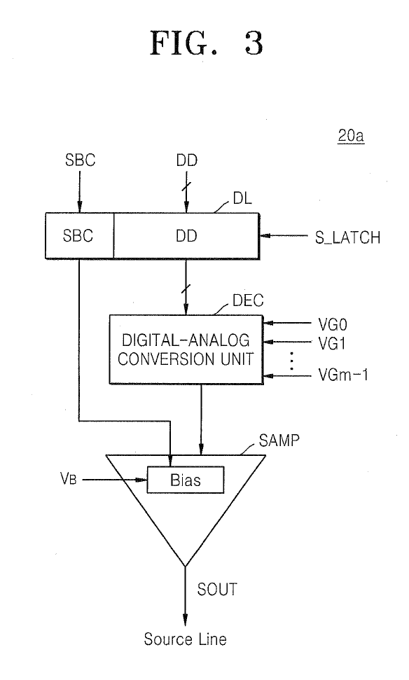

FIG. 3 is a block diagram illustrating a source driving unit 20a of FIG. 1, according to an exemplary embodiment of the inventive concept.

Referring to FIG. 3, the source driving unit 20a may include the data latch DL, a digital-analog conversion unit DEC, and the source amplifier SAMP.

The data latch DL may store the bias control signal SBC and display data DD in response to a latch signal S_LATCH.

The digital-analog conversion unit DEC selects and outputs one gray-scale voltage corresponding to the display data DD from among m gray-scale voltages VG0, VG1, . . . , and VGm−1.

The source amplifier SAMP receives the selected gray-scale voltage as an input signal, buffers the received gray-scale voltage, and outputs the buffered gray-scale voltage as a source driving voltage SOUT. In this case, internal voltages are set such that the source amplifier SAMP may normally operate due to the bias voltage VB received from the bias voltage generating unit 30 (see FIG. 1), and a bias current is controlled by the bias control signal SBC.

The source driving unit 20a sequentially receives display data corresponding to one column driven by the source driving unit 20a on the display panel (not shown), and sequentially outputs the display data as the source driving voltage SOUT through the source amplifier SAMP. A slew rate of the source amplifier SAMP is adjusted by the bias control signal SBC generated and applied by the bias control signal generating unit 10a (see FIG. 2) based on two sequentially applied pieces of display data.

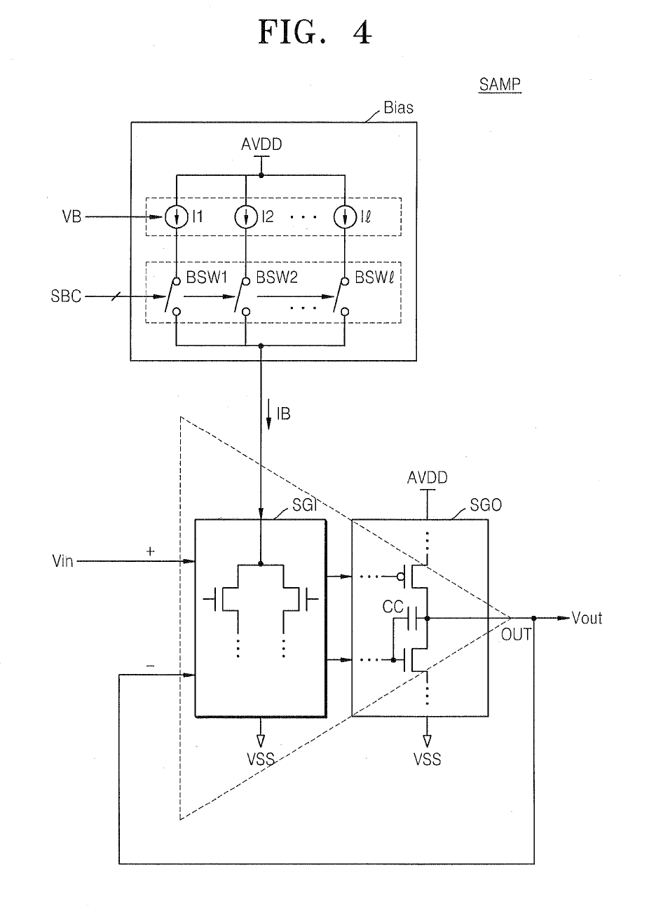

FIG. 4 is a block diagram illustrating the source amplifier SAMP of FIG. 3, according to an exemplary embodiment of the inventive concept.

Referring to FIG. 4, the source amplifier SAMP includes a bias unit Bias, an input unit SGI, and an output unit SGO, and a second input terminal (−) and an output terminal OUT are connected to each other to operate as a buffer.

The bias unit Bias may include a plurality of current sources I1 through I1 and a plurality of bias switches BSW1 through BSW1. The plurality of current sources I1 through I1 which are bias currents may have the same current value or different current values. Current values of the plurality of current sources I1 through I1 may be set in response to the bias voltage VB. For example, the plurality of current sources I1 through I1 may include a transistor, and may have current values corresponding to a difference between a driving voltage AVDD applied to a source of the transistor and the bias voltage VB applied to a gate of the transistor.

The plurality of bias switches BSW1 through BSW1 operate in response to the bias control signal SBC. The first bias switch BSW1 may be turned on or off in response to a first bit of the bias control signal SBC, and the second bias switch BSW2 may be turned on or off in response to a second bit of the bias control signal SBC. When the bias switches BSW1 through BSW1 are turned on in response to the bias control signal SBC, a bias current IB generated in at least one current source connected to the switches which are turned on is applied to the input unit SGI.

The input unit SGI amplifies and outputs an input signal applied to two input terminals (+ and −) based on the bias current IB. The output unit SGO includes a compensation capacitor CC, and amplifies and outputs a signal output from the input unit SGI. In this case, a slew rate of an output signal Vout may be expressed as IB/CC. Accordingly, the bias current IB may be controlled by the bias control signal SBC, and thus a slew rate of the source amplifier SAMP may be determined

Although the source amplifier SAMP includes the bias unit Bias, the input unit SGI, and the output unit SGO in FIG. 4, the present exemplary embodiment is not limited thereto, and various modifications may be made in consideration of required characteristics of the output signal Vout. For example, the source amplifier SAMP may further include an amplification unit for improving characteristics of the output signal Vout.

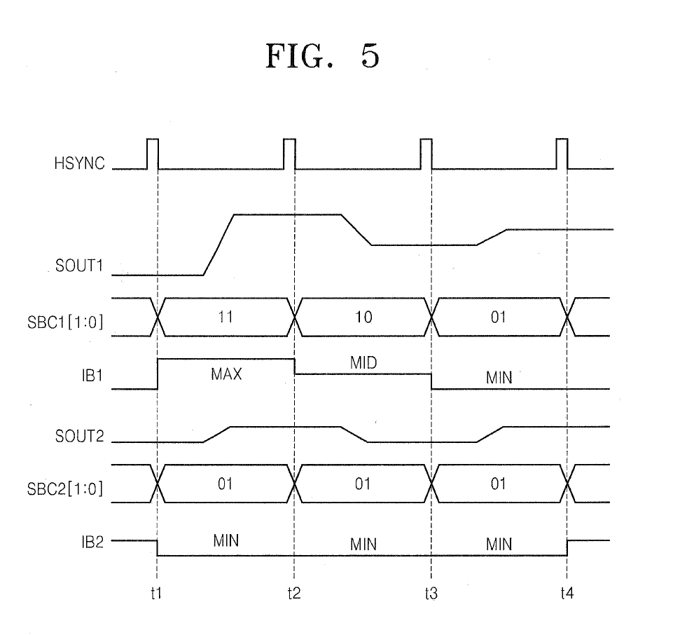

FIG. 5 is a timing chart illustrating waveforms of signals of the source driver 100 including the bias control signal generating unit 10a of FIG. 2 and the source driving unit 20a of FIG. 3, according to an exemplary embodiment of the inventive concept. For convenience, signals of the first source driving unit 20_1 (see FIG. 1) and the second source driving unit 20_2 (see FIG. 1) are shown and described.

Referring to FIG. 5, a horizontal line display time is determined by a horizontal synchronization signal HSYNC. Each of the source driving units 20_1 through 20_n (see FIG. 1) generates and outputs a source driving voltage based on display data in one horizontal line display interval. In FIG. 5, swing widths of the first source driving voltage SOUT1 are different in horizontal line display times t1-t2, t2-t3, and t3-t4. A swing width of the first source driving voltage SOUT1 in the first horizontal line display time t1-t2 is large, a swing width of the first source driving voltage SOUT1 in the second horizontal line display time t2˜t3 is small, and a swing width of the first source driving voltage SOUT1 in the third horizontal line display time t3˜t4 is very small. Accordingly, the first bias control signal SBC1 applied to the first source driving unit 20_1 varies according to horizontal line display times, and a bias current IB1 is also controlled to be different. Since a swing width of the first source driving voltage SOUT1 in the first horizontal line display time t1˜t2 is large, the bias current IB1 flowing in the first horizontal line display time t1˜t2 is the highest MAX, the bias current IB1 flowing in the second horizontal line display time t2˜13 is in the middle MID, and the bias current IB1 flowing in the third horizontal line display time t3˜t4 is the lowest MIN.

Swing widths of the second source driving voltage SOUT2 in the first through third horizontal line display times t1˜t2, t2˜t3, and t3˜t4 are very small. Accordingly, the second bias control signal SBC2 applied to the second source driving unit 20_2 is 01 in all of the first through third horizontal line display times t1˜t2, t2˜t3, and t3˜t4, and a bias current IB2 is controlled to be the lowest MIN.

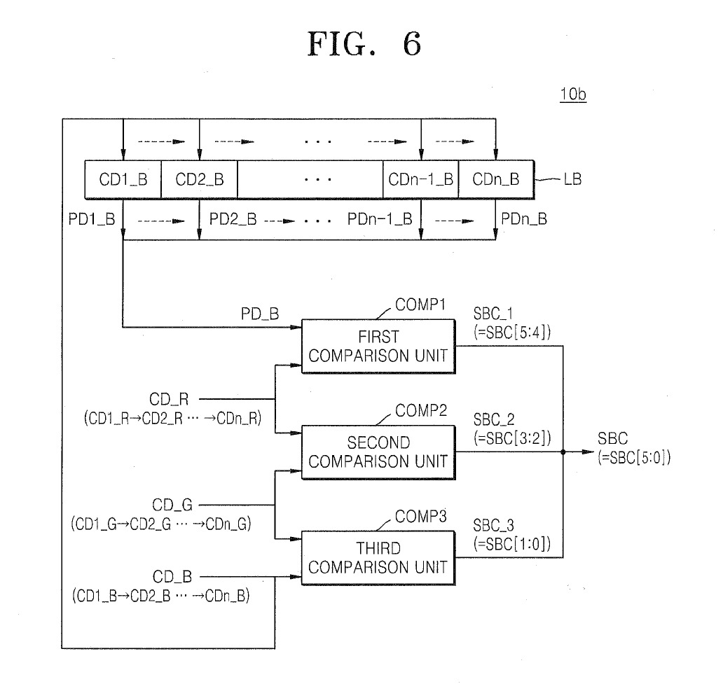

FIG. 6 is a block diagram illustrating a bias control signal generating unit 10b of FIG. 1, according to an exemplary embodiment of the inventive concept.

Referring to FIG. 6, when each of the plurality of source driving units 20_1 through 20_n of FIG. 1 drive a plurality of source lines in a time-division manner for one horizontal line display time, the bias control signal generating unit 10b is a circuit for applying the bias control signal SBC. For reference, one pixel of the display panel (not shown) includes three sub-pixels, in other words, R, G, and B sub-pixels, and each of the plurality of source driving units 20_1 through 20_n drives three source lines respectively connected to the R, G, and B sub-pixels in a time-division manner for one horizontal line display time. When the R, G, and B sub-pixels are driven in the order listed above, the bias control signal generating unit 10b includes three comparison units, in other words, first through third comparison units COMP1, COMP2, and COMP3. However, the present exemplary embodiment is not limited thereto, and the number of comparison units included in the bias control signal generating unit 10b may vary according to the number of source lines of the display panel which each source driving unit drives in a time-division manner.

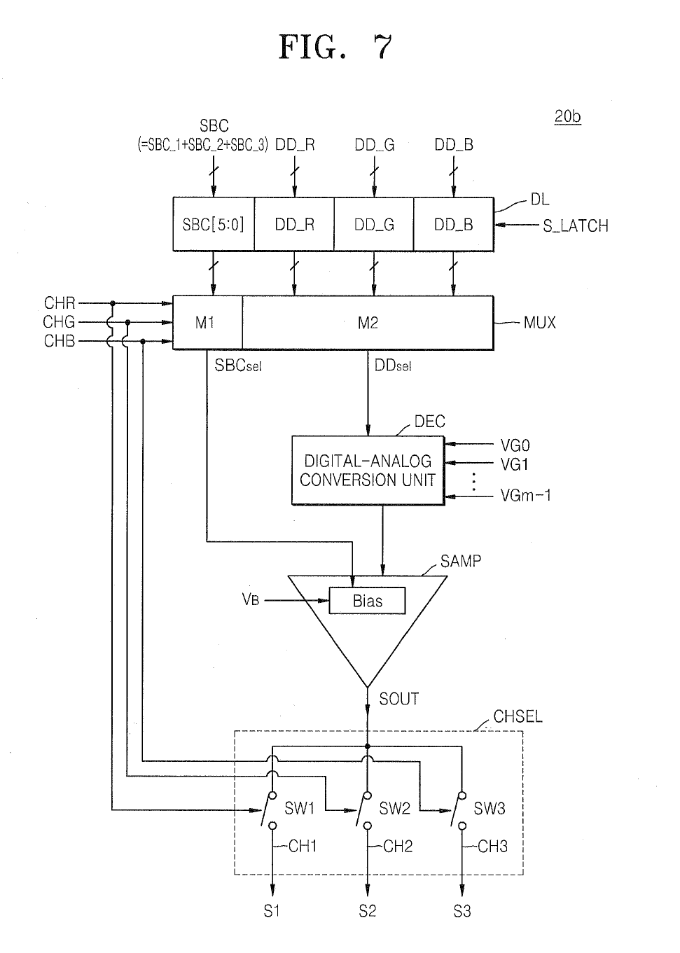

An example of the source driving units 20_1 through 20_n which drive a plurality of source lines in a time-division manner is shown in FIG. 7, and thus the following will be explained with reference to FIGS. 6 and 7.

The display data DD1, DD2, . . . , and DDn (see FIG. 1) respectively applied to the plurality of source driving units 20_1 through 20_n (see FIG. 1) may include first data DD_R (see FIG. 7), second data DD_G (see FIG. 7), and third data DD_B (see FIG. 7) corresponding to R, G, and B sub-pixels. A source driving unit 20b (see FIG. 7) receives the first data DD_R, the second data DD_G, and the third data DD_B, sequentially applies the first data DD_R, the second data DD_G, and the third data DD_B to a source amplifier SAMP (see FIG. 7), and sequentially outputs corresponding source driving voltages to corresponding source lines. In other words, the source amplifier SAMP outputs a source driving voltage corresponding to the first data DD_R, and then outputs a source driving voltage corresponding to the second data DD_G, and finally outputs a source driving voltage corresponding to the third data DD_B.

Referring to FIG. 6, the bias control signal generating unit 10b includes the line buffer LB and the first through third comparison units COMP1, COMP2, and COMP3. The bias control signal generating unit 10b generates the bias control signal SBC based on the display data DD1, DD2, . . . , and DDn (see FIG. 1) respectively applied to the plurality of source driving units 20_1 through 20_n (see FIG. 1), receives some or all of the first, second, and third data DD_R, DD_G, and DD_B included in each display data, and generates first, second, and third sub-bias control signals SBC_1, SBC_2, and SBC_3 based on some or all of the first through third data DD_R, DD_G, and DD_B. The bias control signal generating unit 10b may receive at least part of the first through third data DD_R, DD_G, and DD_B of current display data as first, second, and third current data CD_R, CD_G, and CD_B.

The line buffer LB may delay at least part of data applied as third current data CD1_B through CDn_B a predetermined time, in other words, at least part of the third data DD_B of previous display data may be delayed and output as previous data PD1_B through PDn_B. The third data DD_B is display data finally output in one horizontal line display time. Accordingly, the line buffer LB may store at least part of finally output data from among display data sequentially output in a previous horizontal line display time, and after a predetermined time passes, may output the at least part of the finally output data as the previous data PD1_B through PDn_B. In this case, the predetermined time may correspond to one horizontal line display time.

The first comparison unit COMP1 generates the first sub-bias control signal SBC_1 by comparing previous data PD_B with the first current data CD_R. For example, the first comparison unit COMP1 generates the first sub-bias control signal SBC_1 based on a difference between data finally output through the source driving unit 20b (see FIG. 7) during a previous horizontal line display time with data to be first output from display data applied to the current source driving unit 20b. The second comparison unit COMP2 generates the second sub-bias control signal SBC_2 by comparing the first current data CD_R with the second current data CD_G. For example, the second comparison unit COMP2 generates the second sub-bias control signal SBC_2 based on a difference between the data to be first output and data to be second output from among the display data applied to the current source driving unit 20b (see FIG. 7).

The third comparison unit COMP3 generates the third sub-bias control signal SBC_3 by comparing the second current data CD_G with the third current data CD_B. For example, the third comparison unit COMP3 generates the third sub-bias control signal SBC_3 based on a difference between the data to be second output and display data to be finally output from the display data applied to the current source driving unit 20b (see FIG. 7).

The previous data PD_B, the first current data CD_R, the second current data CD_G, and the third current data CD_B correspond to display data sequentially applied to each source amplifier SAMP. Accordingly, the first through third sub-bias control signals SBC_1, SBC_2, and SBC_3 are generated based on two pieces of display data sequentially applied to the source amplifier SAMP.

In this case, the first through third sub-bias control signals SBC_1, SBC_2, SBC_3 are generated in parallel. The first through third sub-bias control signals SBC_1, SBC_2, SBC_3 may be combined with one another and output as the bias control signal SBC. For example, when each bias control signal is a 2-bit signal, the bias control signal SBC may correspond to a 6-bit signal SBC[5:0], the first sub-bias control signal SBC_1 may correspond to a high-order 2-bit signal SBC[5:4] of the bias control signal SBC, the second sub-bias control signal SBC_2 may correspond to an intermediate 2-bit signal SBC[3:2] of the bias control signal SBC, and the third sub-bias control signal SBC_3 may correspond to a low-order 2-bit signal SBC[1:0] of the bias control signal SBC.

After the bias control signal SBC is generated and output, the third current data CD_B may be stored in the line buffer LB. The third current data CD_B stored in the line buffer LB may be output as previous data PD_B after a predetermined time passes, for example, in a next horizontal driving interval.

The bias control signal generating unit 10b generates the first bias control signal SBC1 corresponding to the first source driving unit 20_1 (see FIG. 1) and outputs the first bias control signal SBC1 to the first source driving unit 20_1, and then generates the second bias control signal SBC2 corresponding to the second source driving unit 20_2 (see FIG. 1) and outputs the second bias control signal SBC2 to the second source driving unit 20_2. As such, the bias control signal generating unit 10b may sequentially generate the plurality of bias control signals SBC1 through SBCn corresponding to the plurality of source driving units 20_1 through 20_n (see FIG. 1) and output the plurality of bias control signals SBC1 through SBCn to the source driving units 20_1 through 20_n. In this case, the bias control signal SBC which is output and data which is applied to and compared by the comparison units COMP1, COMP2, and COMP3 of the bias control signal generating unit 10b are shown in Table 3.

TABLE 3

| COMP1 | | | COMP2 | | | COMP3 | | |
|---|---|---|---|---|---|---|---|---|
| PD_B | CD_R | SBC_1 | CD_R | CD_G | SBC_2 | CD_G | CD_B | SBC_3 |
| PD1_B | CD1_R | SBC1_1 | CD1_R | CD1_G | SBC1_2 | CD1_G | CD1_B | SBC1_3 |
| PD2_B | CD2_R | SBC2_1 | CD2_R | CD2_G | SBC2_2 | CD2_G | CD2_B | SBC2_3 |
| PD3_B | CD3_R | SBC3_1 | CD3_R | CD3_G | SBC3_2 | CD3_G | CD3_B | SBC3_3 |
| . | . | . | . | . | . | . | . | . |
| . | . | . | . | . | . | . | . | . |
| . | . | . | . | . | . | . | . | . |
| PDn_B | CDn_R | SBCn_1 | CDn_R | CDn_G | SBCn_2 | CDn_G | CDn_B | SBCn_3 |

Table 3 shows the bias control signal SBC which is output and the data which is applied to and compared by the comparison units COMP1, COMP2, and COMP3. Referring to FIG. 3, the first comparison unit COMP1 generates a first sub-bias control signal SBC1_1 by comparing first current data CD1_R with previous data PD1_B of the first display data DD1 (see FIG. 1). The second comparison unit COMP2 generates a second sub-bias control signal SBC1_2 by comparing second current data CD1_G with the first current data CD1_R of the first display data DD1 (see FIG. 1). The third comparison unit COMP3 generates a third sub-bias control signal SBC1_3 by comparing third current data CD1_B with the second current data CD1_G of the first display data DD1 (see FIG. 1). The first sub-bias control signal SBC1_1, the second sub-bias control signal SBC1_2, and the third sub-bias control signal SBC1_3 are output as the first bias control signal SBC1 to the first source driving unit 20_1.

Next, the first comparison unit COMP1 generates a first sub-bias control signal SBC2_1 by comparing first current data CD2_R with previous data PD2_B of the second display data DD2 (see FIG. 1). The second comparison unit COMP2 generates a second sub-bias control signal SBC2_2 by comparing second current data CD2_G with the first current data CD2_R of the second display data DD2 (see FIG. 1). The third comparison unit COMP3 generates a third sub-bias control signal SBC2_3 by comparing third current data CD2_B with the second current data CD2_G of the second display data DD2 (see FIG. 1). Accordingly, the first sub-bias control signal SBC2_1, the second sub-bias control signal SBC2_2, and the third sub-bias control signal SBC2_3 are output as the second bias control signal SBC2 to the second source driving unit 20_1. Accordingly, the remainder of the bias control signals SBC3 to SBCn applied to the remainder of the source driving units 20_3 to 20_n (see FIG. 1) may be generated and output through the above process.

As described above, the bias control signal generating unit 10b may sequentially generate the plurality of bias control signals SBC1 through SBCn respectively corresponding to the plurality of source driving units 20_1 through 20_n (see FIG. 1) and output the plurality of bias control signals SBC1 through SBCn to the source driving units 20_1 through 20_n.

FIG. 7 is a block diagram illustrating the source driving unit 20b of FIG. 1, according to an exemplary embodiment of the inventive concept. In FIG. 7, the source driving unit 20b drives a plurality of source lines in a time-division manner.

Referring to FIG. 7, the source driving unit 20b includes the data latch DL, a multiplexer MUX, the digital-analog conversion unit DEC, the source amplifier SAMP, and a channel selection unit CHSEL.

The data latch DL stores the bias control signal SBC, the first data DD_R, the second data DD_G, and the third data DDB in response to the latch signal S_LATCH, and outputs the bias control signal SBC, the first data DD_R, the second data DD_G, and the third data DDB to the multiplexer MUX.

The multiplexer MUX selects display data (at M2) and some bits of the bias control signal SBC (at M1) in response to channel selection signals CHR, CHG, and CHB which are activated at different points of time. Since the bias control signal SBC is obtained by combining the first through third sub-bias control signals SBC_1, SBC_2, and SBC_3 (see FIG. 6), when some bits of the bias control signal SBC are selected, it may mean that one sub-bias control signal is selected from among the first through third sub-bias control signals SBC_1, SBC_2, and SBC_3. For example, when the first channel selection signal CHR is activated, the first sub-bias control signal SBC_1 and the first data DD_R may be selected and output.

The digital-analog conversion unit DEC selects a gray-scale voltage corresponding to a display signal DDsel selected and output by the multiplexer MUX and outputs the selected gray-scale voltage to the source amplifier SAMP. The source amplifier SAMP allows a bias current to be controlled according to a selected sub-bias control signal SBCsel, amplifies an input signal, and outputs the amplified input signal as the source driving voltage SOUT. The digital-analog conversion unit DEC and the source amplifier SAMP are substantially the same as the digital-analog conversion unit DEC and the source amplifier SAMP of FIG. 3, and thus a detailed explanation thereof will not be given.

The channel selection unit CHSEL selects one of a plurality of channels CH1, CH2, and CH3 in response to the channel selection signals CHR, CHG, and CHB and outputs the source driving voltage SOUT through the selected channel. The channel selection unit CHSEL may include a plurality of switches SW1, SW2, and SW3. The switches SW1, SW2, and SW3 may be turned on or off in response to the channel selection signals CHR, CHG, and CHB. Since the channel selection signals CHR, CHG, and CHB are activated at different points of time, one of the plurality of switches SW1, SW2, and SW3 is turned on and one channel is selected.

The first, second, and third channel selection signals CHR, CHG, and CHB are sequentially activated in one horizontal line display driving interval. In an interval where the first channel selection signal CHR is activated, a gray-scale voltage corresponding to the first data DD_R is output as the source driving voltage SOUT through the first channel CH1 to a first source line S1. In an interval where the second channel selection signal CHB is activated, a gray-scale voltage corresponding to the second data DD_G is output as the source driving voltage SOUT through the second channel CH2 to a second source line S2. In an interval where the third channel selection signal CHB is activated, a gray-scale voltage corresponding to the third data DD_B may be output as the source driving voltage SOUT through the third channel CH3 to a third source line S3. In this case, a bias current of the source amplifier SAMP is controlled by the first through third sub-bias control signals SBC_1, SBC_2, and SBC_3 generated according to a difference between data which is displayed in each interval and data which is previously displayed.

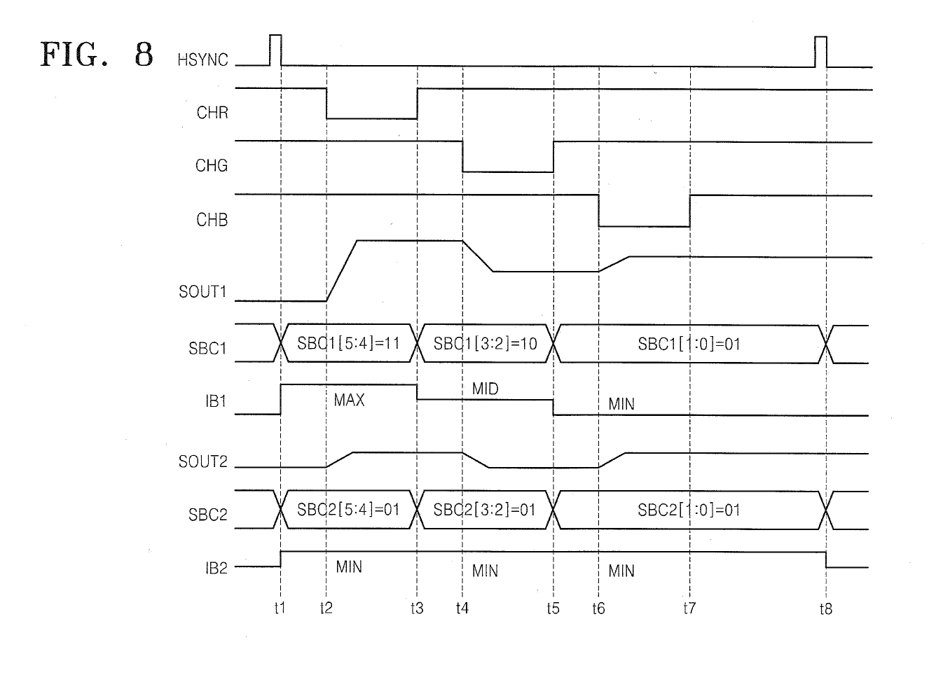

FIG. 8 is a timing chart illustrating waveforms of signals of the source driver 100 including the bias control signal generating unit 10b of FIG. 6 and the source driving unit 20b of FIG. 7, according to an exemplary embodiment of the inventive concept. For convenience of explanation, a bias current of each of the first source driving unit 20_1 (see FIG. 1) and the second source driving unit 20_2 (see FIG. 1) is controlled in three steps.

The source driving unit 20b of FIG. 7 drives three source lines in a time-division manner in one horizontal line display time t1˜t8. Accordingly, each source driving unit outputs a gray-scale voltage corresponding to each display data as a source driving voltage in every interval where the first through third channel selection signals CHR, CHG, and CHB are activated. In this case, a bias current of the source amplifier SAMP is controlled by a bias control signal selected by each of the channel selection signals CHR, CHG, and CHB. When the first and second bias control signals SBC1 and SBC2 generated by the bias control signal generating unit 10b and applied to each source driving unit are 6-bit signals, first, second, and third sub-bias control signals may be 2-bit signals included in each of the bias control signals SBC1 and SBC2. In an interval where the first channel selection signal CHR is activated, a first sub-bias control signal SBC1[5:4] may be selected and applied to the source amplifier SAMP. In an interval where the second channel selection signal CHG is activated, a second sub-bias control signal SBC1[3:2] may be selected and applied to the source amplifier SAMP. In an interval where the third channel selection signal CHB is activated, a third sub-bias control signal SBC1[1:0] may be selected and applied to the source amplifier SAMP.

In this case, a swing width of the source driving voltage SOUT1 of the first source driving unit 20_1 (see FIG. 1) varies according to intervals. A swing width of the source driving voltage SOUT1 in a first interval t2˜t3 is large, a swing width of the source driving voltage SOUT1 in a second interval t4˜t5 is small, and a swing width of the source driving voltage SOUT1 in a third interval t6˜t7 is very small. Accordingly, bias control signals are different according to intervals. In other words, the first sub-bias control signal SBC1[5:4] applied to the source amplifier SAMP of the first source driving unit 20_1 in the first interval t2˜t3 is 11, the second sub-bias control signal SBC1[3:2] applied in the second interval t4˜t5 is 10, and the third sub-bias control signal SBC1[1:0] applied in the third interval t6˜t7 is 01. Accordingly, the bias current IB1 is differently controlled in intervals.

A swing width of the source driving voltage SOUT2 of the second source driving unit 202 (see FIG. 1) is very small in each interval. Accordingly, all of the first sub-bias control signal SBC2[5:4], the second sub-bias control signal SBC2[3:2], and the third sub-bias control signal SBC2[1:0] applied to the source amplifier SAMP of the second source driving unit 20_2 are 01, and a bias current of the source amplifier SAMP is controlled to be the lowest.

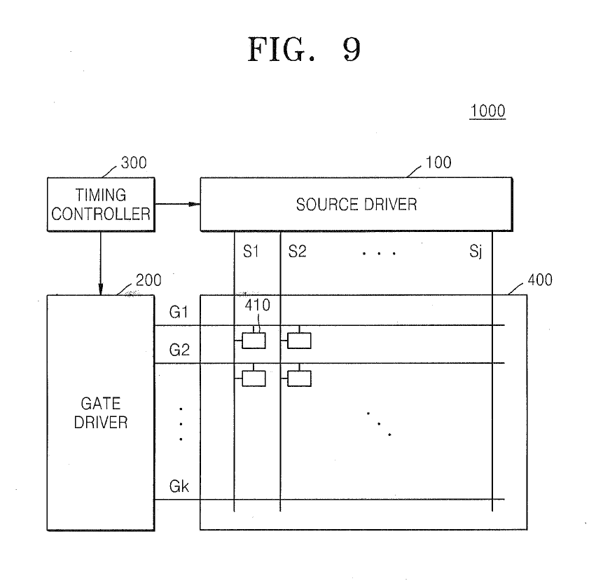

FIG. 9 is a block diagram illustrating a display system 1000 according to an exemplary embodiment of the inventive concept. FIG. 1 illustrates the source driver 100 of the display system 1000 of FIG. 9:

Referring to FIG. 9, the display system 1000 includes the source driver 100, a gate driver 200, a timing controller 300, and a display panel 400.

The display panel 400 may be, for example, a liquid crystal display (LCD) device. K gate lines G1 through Gk that transmit a scan signal in a row direction and j source lines S1 through Sj that transmit a data signal in a column direction are arranged on the display panel 400, and a plurality of pixels 410 are arranged between the gate lines G1 through Gk and the source lines S1 through Sj.

The timing controller 300 generates a control signal for controlling the source driver 100 and the gate driver 200, processes external display data, and transmits the received display data to the source driver 100.

The source driver 100 receives the display data applied from the timing controller 300, generates an analog gray-scale signal corresponding to the received display data, and outputs the analog gray-scale signal to the source lines S1 through Sj of the display panel 400. Since the source driver 100 generates a bias control signal based on a difference between current data and previous data of the display data corresponding to each source driving unit, and accordingly controls a bias current of each source amplifier, excessive bias currents may be prevented from flowing, thereby reducing power consumption.

The gate driver 200 sequentially activates the gate lines G1 through Gk of the display panel 400 according to the control signal applied from the timing controller 300.

Accordingly, optical properties of pixels of the activated gate lines of the display panel 400 are adjusted according to the analog gray-scale signal applied to the source lines S1 through Sj to display image data.

An exemplary embodiment of the inventive concept may be applied to a flat panel display device using a driving method similar to that of an LCD device, such as an electrochromic display (ECD) device, a digital mirror device (DMD), an actuated mirror device (AMD), a grating light valve (GLV) device, a plasma display panel (PDP), an electroluminescent display (ELD) device, a light emitting diode (LED) display device, or a vacuum fluorescent display (VFD) device. A display device to which an exemplary embodiment of the inventive concept is applied may be a large-screen TV, a high-definition television (HDTV), a portable computer, a camcorder, a display device for a vehicle, an information and communication multimedia system, and a virtual reality system.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A source driver for a display device, the source driver comprising:
a first source driving unit comprising a first source amplifier that controls a first slew rate in response to a first bias control signal and generates a first source driving voltage corresponding to first display data;
a second source driving unit comprising a second source amplifier that controls a second slew rate in response to a second bias control signal and generates a second source driving voltage corresponding to second display data; and
a bias control signal generating unit that sequentially generates the first and second bias control signals, and applies the first and second bias control signals respectively to the first and second source driving units,
wherein the first bias control signal is based on a difference between the first display data sequentially applied to the first source amplifier and the second bias control signal is based on a difference between the second display data applied to the second source amplifier.

2. The source driver of claim 1, wherein the first source amplifier adjusts the first slew rate by controlling an amount of a bias current in response to the first bias control signal.

3. The source driver of claim 1, wherein the bias control signal generating unit generates the first bias control signal to increase a bias current of the first source amplifier as the difference between the first display data increases.

4. The source driver of claim 1, further comprising a bias voltage generating unit that applies a bias voltage to the first and second source amplifiers,
wherein bias currents of the first and second source amplifiers are generated in response to the bias voltage, and an amount of the bias current of the first source amplifier is controlled in response to the first bias control signal and an amount of the bias current of the second source amplifier is controlled in response to the second bias control signal.

5. The source driver of claim 1, wherein the first display data comprises current display data and previous display data that is applied to the first source amplifier prior to the current display data,
wherein the bias control signal generating unit comprises:
a line buffer that buffers at least part of the previous display data and outputs the at least part as previous data; and
a comparison unit that generates the first bias control signal based on a difference between the previous data and current data corresponding to at least part of the current display data.

6. The source driver of claim 1, wherein the first source driving unit comprises:
a data latch that receives and stores the first bias control signal and the first display data;
a digital-analog conversion unit that selects a gray-scale voltage corresponding to the first display data from among a plurality of gray-scale voltages; and
the first source amplifier that controls the first slew rate to be adjusted in response to the first bias control signal, and outputs the selected gray-scale voltage as the first source driving voltage.

7. The source driver of claim 1, wherein the first source driving unit sequentially drives a plurality of source lines of a display panel in a time-division manner.

8. The source driver of claim 1, wherein the first display data comprises previous display data and current display data that are sequentially applied to the first source driving unit and each of the previous and current display data comprise first data, second data, and third data sequentially applied to the first source amplifier, and the bias control signal generating unit comprises:
a line buffer that buffers the third data of the previous display data and outputs the third data as previous data;
a first comparator that generates a first sub-bias control signal based on a difference between the previous data and the first data of the current display data;
a second comparator that generates a second sub-bias control signal based on a difference between the first data and the second data of the current display data; and
a third comparator that generates a third sub-bias control signal based on a difference between the second data and the third data of the current display data.

9. The source driver of claim 8, wherein the bias control signal generating unit generates the first, second, and third sub-bias control signals, and outputs the first, second, and third sub-bias control signals as the first bias control signal to the first source driving unit.

10. The source driver of claim 8, wherein the first source driving unit comprises:
a data latch that receives and stores the first, second, and third sub-bias control signals and the current first, second, and third data;
a multiplexer that sequentially selects and outputs the first, second, and third sub-bias control signals in response to a channel selection signal, and sequentially selects and outputs the current first, second, and third data;
a digital-analog conversion unit that selects a gray-scale voltage corresponding to the selected data from among a plurality of gray-scale voltages;
the first source amplifier controls the first slew rate to be adjusted in response to the selected sub-bias control signal, and outputs the selected gray-scale voltage as the first source driving voltage; and
a channel selection unit that sequentially outputs the first source driving voltage through a first channel, a second channel, and a third channel in response to the channel selection signal.

11. A method of operating a source driver comprising a plurality of source amplifiers, the method comprising:
generating a plurality of bias control signals based on a difference between display data sequentially applied to the plurality of the source amplifiers;
respectively controlling slew rates of the plurality of source amplifiers based on the plurality of bias control signals; and
generating source driving voltages using the plurality of source amplifiers.

12. The method of claim 11, wherein the plurality of bias control signals are sequentially generated in a bias control signal generating unit, and each of the plurality of bias control signals is applied to a corresponding one of the plurality of source amplifiers.

13. The method of claim 11, wherein generating the plurality of bias control signals comprises:
generating a first bias control signal of the plurality of bias control signals based on a difference between previous display data output from a line buffer and current display data; and
storing the current display data in the line buffer.

14. The method of claim 11, wherein the display data comprise first data, second data and third data, and each of the plurality of bias control signals comprise first, second and third sub-bias control signals, and
wherein generating a first bias control signal of the plurality of bias control signals comprises:
generating the first sub-bias control signal based on a difference between the third data of previous display data output from a line buffer and the first data of current display data;
generating the second sub-bias control signal based on a difference between the first data and the second data of the current display data;
generating the third sub-bias control signal based on a difference between the second data and the third data of the current display data; and
storing the third data of the current display data in the line buffer.

15. The method of claim 14, wherein a first source amplifier of the plurality of source amplifiers outputs a source driving voltage corresponding to the first data of the current display data when a slew rate of the first source amplifier is adjusted by the first sub-bias control signal, outputs a source driving voltage corresponding to the second data of the current display data when the slew rate of the first source amplifier is adjusted by the second sub-bias control signal, and outputs a source driving voltage corresponding to the third data of the current display data when the slew rate of the first source amplifier is adjusted by the third sub-bias control signal.

16. A source driver, comprising:
a source driving unit configured to output a source driving voltage in response to a bias control signal; and
a bias control signal generating unit configured to generate the bias control signal in response to first display data stored in the bias control signal generating unit and second display data input to the bias control signal generating unit.

17. The source driver of claim 16, wherein a slew rate of the source driving voltage is changed by the bias control signal.

18. The source driver of claim 16, wherein the bias control signal includes first and second sub-bias control signals.

19. The source driver of claim 18, wherein a first bias current corresponding to the first sub-bias control signal is different than a second bias current corresponding to the second sub-bias control signal.

20. The source driver of claim 16, wherein the bias control signal generating unit includes a buffer to store the first display data and a comparator to compare the first display data with the second display data.
